(19) United States
(12) Patent Application Publication
(10) Pub. No.: US 2026/0094968 A1
(43) Pub. Date: Apr. 2, 2026

(54) RADOME WITH CIRCULARLY POLARIZED METAMATERIAL AND ANTENNA ASSEMBLY

(71) Applicant: Cyntec Co., Ltd., Hsinchu (TW)

(72) Inventor: Chi-Ho Chang, Hsinchu (TW)

(73) Assignee: Cyntec Co., Ltd., Hsinchu (TW)

(21) Appl. No.: 19/336,514

(22) Filed: Sep. 23, 2025

Related U.S. Application Data
(60) Provisional application No. 63/701,546, filed on Sep. 30, 2024.

(51) Int. Cl. H01Q 9/04; H01Q 1/42; H01Q 15/00; H01Q 21/06

(52) U.S. Cl. CPC H01Q 9/0428; H01Q 1/42; H01Q 15/0086; H01Q 21/061

(57) ABSTRACT

The present invention provides a radome incorporating a circularly polarized metamaterial, including a dielectric carrier and a circularly polarized metamaterial layer attached to or embedded into the dielectric carrier and electrically floating with respect to ground. The circularly polarized metamaterial layer includes a plurality of X-shaped openings arranged in an array and exposing the dielectric carrier, and a first radiation pattern transmits through the circularly polarized metamaterial layer, resulting in a second radiation pattern having enhanced focusing characteristics compared to the first radiation pattern.

### CROSS REFERENCE TO RELATED APPLICATIONS

This application claims the benefit of U.S. Provisional Application No. 63/701,546, filed on Sep. 30, 2024. The content of the application is incorporated herein by reference.

### BACKGROUND OF THE INVENTION

### 1. Field of the Invention

The present invention generally relates to a radome, and more specifically, to a radome with circularly polarized metamaterial and antenna assembly

### 2. Description of the Related Art

A radome (short for radar dome) is a protective enclosure that covers or houses an antenna, especially radar antennas-without interfering with the transmission or reception of electromagnetic signals. It serves to shield the antenna from environmental factors such as rain, snow, dust, wind, and physical impact. At the same time, it is constructed from materials that are transparent to radio waves, ensuring that signal integrity is maintained without distortion or blockage.

While the radome primarily serves to protect the antenna from environmental and physical damage, guiding structures (for guiding radio waves to penetrate the radome) can be integrated into the radome to enhance the antenna's overall performance. In the context of radome design, a guiding structure refers to an engineered path or material configuration—either within or on the radome surface—that guides, controls, or filters electromagnetic waves. These structures are particularly useful for improving signal performance, reducing interference, and enabling advanced electromagnetic functionalities. For example, a guiding structure in radome may include frequency selective surfaces (FSS)—allow specific frequency bands to pass while blocking others. By guiding, filtering, or confining signals, these structures help reduce transmission loss, improve efficiency, and ensure optimal performance for sensitive radar and communication systems. More specifically, metamaterials can be embedded within guiding structures to realize novel wave propagation effects that are unattainable with conventional materials alone. For instance, guiding structures integrated with high-impedance surfaces (HIS) or electromagnetic bandgap (EBG) metamaterials can achieve enhanced antenna isolation and reduced interference. These advanced materials provide new means to engineer the electromagnetic properties within or around guiding structures, enabling precise and advanced control over wave propagation.

In current 5G and low Earth orbit (LEO) satellite communications, dual-polarized and circularly polarized antenna arrays are commonly employed as the primary radio frequency (RF) transmission medium. Unlike linearly polarized metamaterials, which are typically used in radar antenna systems to effectively enhance detection range, circularly polarized metamaterials address different functional requirements. Radar systems rely on linear polarization to mitigate interference through polarization discrimination and to improve microwave radiation efficiency. Conversely, communication systems require broader antenna coverage and the capability to receive signals from multiple directions. To enhance antenna gain in these applications, those of skilled in the art need to design circularly polarized metamaterials with characteristics of negative refractive index, aiming to achieve improved performance in signal reception and transmission for modern communication networks.

### SUMMARY OF THE INVENTION

In response to the growing demand for efficient signal transmission and reception in modern communication networks, the present invention hereby proposes a novel radome integrated with circularly polarized metamaterials, featuring a unique array of X-shaped openings patterned within the metamaterial structure. This design provides outstanding antenna gain enhancement for circularly polarized antennas, dual-polarized antennas, and linearly polarized antennas alike. It is particularly effective in applications involving directional communication or antennas with narrow scanning angles. Moreover, the proposed radome is well-suited for low Earth orbit (LEO) satellite communication systems with mechanically rotating structures, as it can reduce the number of required antennas and lower overall power consumption.

One aspect of the present invention is to provide a radome with circularly polarized metamaterial, including: a dielectric carrier; and a circularly polarized metamaterial layer attached to or embedded into the dielectric carrier and electrically floating with respect to ground, the circularly polarized metamaterial layer comprises a plurality of X-shaped openings arranged in an array and exposing the dielectric carrier, and a first radiation pattern transmits through the circularly polarized metamaterial layer, resulting in a second radiation pattern with enhanced focusing characteristics compared to the first radiation pattern.

Another aspect of the present invention is to provide an antenna assembly, including: an antenna array; and a radome with circularly polarized metamaterial, wherein the antenna array is disposed beneath the radome and completely overlap the radome, and the radome includes: a dielectric carrier; and a circularly polarized metamaterial layer attached to or embedded into the dielectric carrier and electrically floating with respect to ground and a feeding terminal of the antenna array, the circularly polarized metamaterial layer comprises a plurality of X-shaped openings arranged in an array and exposing the dielectric carrier, and a first radiation pattern transmits through the circularly polarized metamaterial layer, resulting in a second radiation pattern with enhanced focusing characteristics compared to the first radiation pattern.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a top-view diagram of a radome with circularly polarized metamaterial in accordance with an embodiment of the present invention.

FIG. 2 presents an isometric view of a radome with circularly polarized metamaterial in accordance with an embodiment of the present invention.

FIG. 3 illustrates a top-view diagram of a square unit cell within the circularly polarized metamaterial layer in accordance with an embodiment of the present invention.

FIG. 4 illustrates a top-view diagram of an antenna assembly in accordance with an embodiment of the present invention.

FIG. 5 presents an isometric view of an antenna assembly in accordance with an embodiment of the present invention.

FIG. 6 illustrates a cross-sectional diagram of an antenna assembly having a flat radome in accordance with an embodiment of the present invention.

FIG. 7 illustrates a cross-sectional diagram of an antenna assembly having a curved radome in accordance with an alternative embodiment of the present invention.

FIG. 8 presents a plot of S-parameters versus frequency in the TE Mode based on Floquet Port analysis of the antenna array incorporating the radome in accordance with the embodiment of the present invention.

FIG. 9 presents a plot of S-parameters versus frequency in the TM Mode based on Floquet Port analysis of the antenna array incorporating the radome or/and the square unit cells in accordance with the embodiment of the present invention.

FIG. 10 presents a plot of antenna gains versus Azimuth (Az) angular coordinate.

FIG. 11 presents a plot of antenna gains versus Elevation (EL) angular coordinate.

Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

Reference will now be made in detail to exemplary embodiments of the invention, which are illustrated in the accompanying drawings in order to understand and implement the present disclosure and to realize the technical effect. It can be understood that the following description has been made only by way of example, but not to limit the present disclosure. Various embodiments of the present disclosure and various features in the embodiments that are not conflicted with each other can be combined and rearranged in various ways. Without departing from the spirit and scope of the present disclosure, modifications, equivalents, or improvements to the present disclosure are understandable to those skilled in the art and are intended to be encompassed within the scope of the present disclosure.

It should be readily understood that the meaning of “on,” “above,” and “over” in the present disclosure should be interpreted in the broadest manner such that “on” not only means “directly on” something but also includes the meaning of “on” something with an intermediate feature or a layer therebetween, and that “above” or “over” not only means the meaning of “above” or “over” something but can also include the meaning it is “above” or “over” something with no intermediate feature or layer therebetween (i.e., directly on something). Further, spatially relative terms, such as “beneath,” “below,” “lower,” “above,” “upper,” and the like, may be used herein for ease of description to describe one element or feature relationship to another element(s) or feature(s) as illustrated in the figures.

As used herein, the term “layer” refers to a material portion including a region with a thickness. A layer can extend over the entirety of an underlying or overlying structure, or may have an extent less than the extent of an underlying or overlying structure. Further, a layer can be a region of a homogeneous or inhomogeneous continuous structure that has a thickness less than the thickness of the continuous structure. For example, a layer can be located between any pair of horizontal planes between, or at, a top surface and a bottom surface of the continuous structure. A layer can extend horizontally, vertically, and/or along a tapered surface. A substrate can be a layer, can include one or more layers therein, and/or can have one or more layer thereupon, thereabove, and/or therebelow. A layer can include multiple layers. For example, an interconnect layer can include one or more conductor and contact layers (in which contacts, interconnect lines, and/or through holes are formed) and one or more dielectric layers.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. Additionally, the term “based on” may be understood as not necessarily intended to convey an exclusive set of factors, but may allow for the presence of other factors not necessarily expressly described, again depending at least in part on the context.

It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Examples of the present invention include metamaterials, such as metamaterial lenses engineered to exhibit material properties that approximate a low effective refractive index (e.g., 0≤n≤1) and even negative refractive index. These metamaterials can be designed and tuned using dispersion engineering to create a relatively wideband, low or negative index lens. The metamaterial is integrated into the radome (short for radar dome) structure for use in antenna array designs, including circularly polarized, dual-polarized, and linearly polarized antennas, and may collectively form part of a complete antenna assembly.

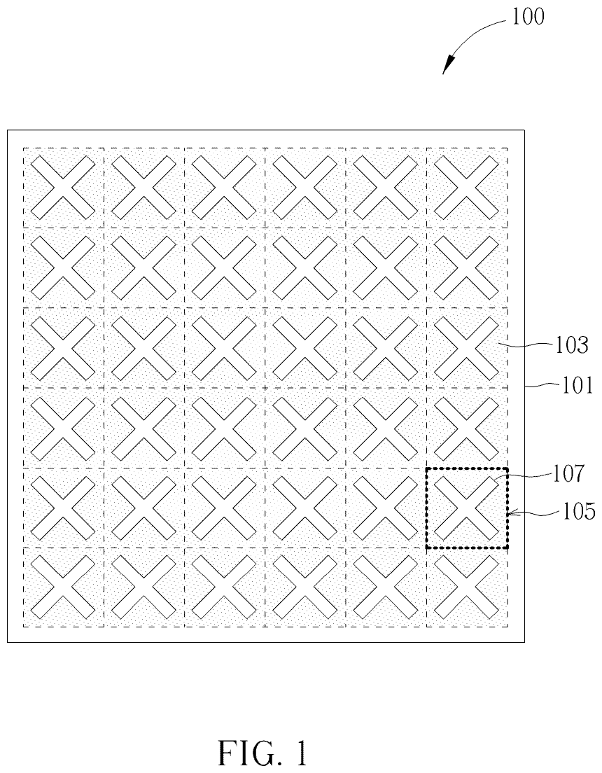

Please refer to FIG. 1, which illustrates a top-view diagram of a radome 100 incorporating circularly polarized metamaterial in accordance with an embodiment of the present invention. The radome 100 of the present invention is specifically designed as a protective enclosure or housing for antenna—particularly radar antennas—providing environmental shielding without interfering with the transmission or reception of electromagnetic signals. It protects the antenna from adverse conditions such as rain, snow, dust, wind, and physical impacts. At the same time, it is constructed from materials that are transparent to radio waves, ensuring signal integrity without significant distortion or attenuation. In the embodiment, the radome 100 generally includes a dielectric carrier 101 and a circularly polarized metamaterial layer 103 attached to or embedded into the dielectric carrier 101. The dielectric carrier 101 serves as the main structural body of the radome 100 and functions as the foundation upon which other components are formed. The material of the dielectric carrier 101 is specially selected to protect the antenna systems while allowing electromagnetic signals to pass through with minimal attenuation or distortion. Suitable materials for dielectric carrier 101 include, but are not limited to, PC (polycarbonate), acrylic, fiberglass, PTFE (Polytetrafluoroethylene) composites, quartz or ceramics. In the illustrated embodiment, the planar area of the dielectric carrier 101—on which the circularly polarized metamaterial layer 103 is formed—is larger than the area of the metamaterial layer 103 itself. Moreover, the shape of the planar region of the dielectric carrier 101 is not limited to the square configuration depicted in FIG. 1. While a quadrilateral shape is preferred, the planar region may alternatively be rectangular, circular, polygonal, or even irregular, depending on design considerations or specific application requirements.

In an alternative embodiment, the radome 100 may be implemented using a printed circuit board (PCB) with electromagnetic bandgap (EBG) guiding structures. PCBs of this type exhibit slow-wave, high-impedance surface (HIS) characteristics, e.g., the circularly polarized metamaterial layer 103, which may also be referred to as frequency selective surfaces (FSS). When an incident electromagnetic field strikes the surface of such a structure, it induces surface currents. These currents generate scattered fields. The total electromagnetic field at any point in space is therefore the superposition of the reflected and transmitted fields produced by the interaction of the induced surface currents and the dielectric interfaces. This behavior can be leveraged to enhance the radiation performance of the antenna.

Refer still to FIG. 1. The circularly polarized metamaterial layer 103 is formed on the planar surface of the radome 100. In the illustrated embodiment, an array of square unit cells 105, ex. 6×6 configuration, is defined on the circularly polarized metamaterial layer 103, wherein each square unit cell 105 includes and corresponds to a respective X-shaped opening 107. With this configuration, a plurality of X-shaped openings 107 are arranged in an array pattern that conforms to the layout of the square unit cells 105 and exposing the dielectric carrier 101 underneath. Notably, the square unit cells 105 are not physically separated from one another; instead, they are structurally connected, collectively forming the continuous structure of the circularly polarized metamaterial layer 103. Each X-shaped opening 107 is preferably positioned at the center of its corresponding square unit cell 105. The planar shape of the circularly polarized metamaterial layer 103 is preferably, but not limited to, a quadrilateral, and is preferably aligned such that its edges are parallel to the edges of the underlying dielectric carrier 101. The circularly polarized metamaterial layer 103 is preferably fabricated from materials such as ceramic, RO4835 or FR4, and may form part of the aforementioned PCB incorporating electromagnetic bandgap (EBG) guiding structures.

Particularly, the circularly polarized metamaterial layer 103 of the present invention exhibits a negative refractive index, classifying it as a negative-index metamaterials (NIMs). Negative-index metamaterials are artificially engineered structures that exhibit a negative refractive index within a specific frequency range. Unlike naturally occurring materials, which typically have positive permittivity (ε) and positive permeability (μ), negative-index metamaterials are designed such that both permittivity and permeability are simultaneously negative. This unusual combination results in a negative refractive index (n<0)—a property does not exist in natural materials. In conventional dielectric structures, the refractive index governed by Snell's Law is always positive, causing electromagnetic waves to diverge and thereby degrading antenna radiation performance. In contrast, when a negative-index metamaterial is used, the refracted wave bends toward the incident side, similar to the focusing behavior of a convex lens in optics. This effect enables the incident energy to be redirected and concentrated, thereby enhancing antenna gain and improving radiation efficiency. In practice, the metamaterial is affixed to the radome 100, forming a three-layer dielectric structure consisting of air, the circularly polarized metamaterial layer 103, and the dielectric carrier 101—each with its own refractive index. To effectively enhance the main beam gain of the antenna, the absolute value of the negative refractive index of the circularly polarized metamaterial layer 103 should be greater than the positive refractive index of the dielectric carrier 101, and the relative permittivity (εᵣ) of the dielectric carrier 101 may ranges from 2.0 to 4.4.

It is important to note that the unique behavior of the circularly polarized metamaterial layer 103 in the present invention arises not from the intrinsic properties of the base material, but rather from the geometry, shape, size, orientation, and arrangement of its sub-wavelength structural units—namely, the X-shaped openings 107 within the square unit cells 105. When a first radiation pattern transmits through the circularly polarized metamaterial layer 103 of the radome 100—including the array of X-shaped openings 107 formed thereon—a second radiation pattern is produced, exhibiting improved focusing characteristics compared to the first radiation pattern.

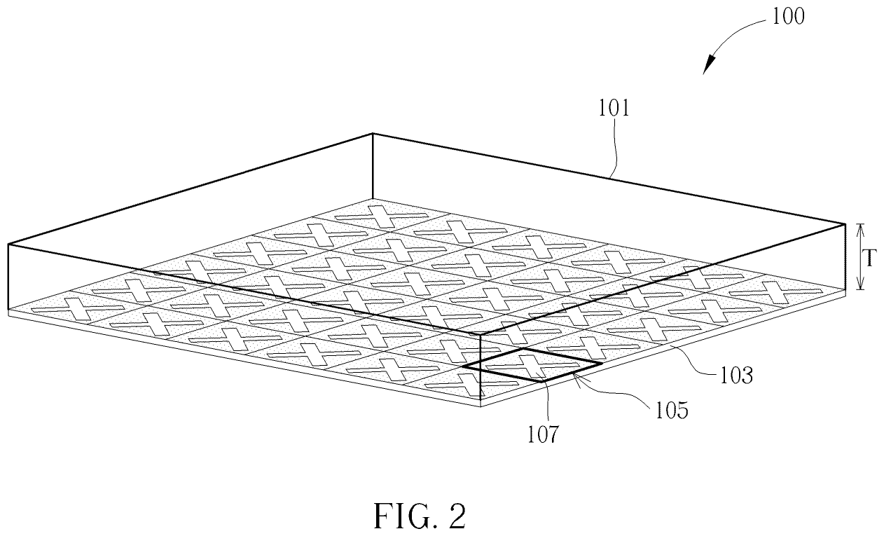

Please refer to FIG. 2, which presents an isometric view of the radome 100 in accordance with an embodiment of the present invention. As shown in the figure, the radome 100 includes a relatively thick dielectric carrier 101 and a thin circularly polarized metamaterial layer 103 attached to or embedded into the dielectric carrier 101. To prevent severe distortion of the antenna radiation pattern caused by standing wave null effects in near-field antenna systems designed to operate within a specific and limited range, the thickness T of the dielectric carrier 101—measured in a direction orthogonal to the incident plane (i.e., the plane to which the circularly polarized metamaterial layer 103 is attached) is preferably designed as an integer multiple of half the guided wavelength within the dielectric carrier 101 of the radome 100. Meanwhile, the thickness of circularly polarized metamaterial layer 103 in the same direction is preferably in the range of 0.5 mil to 2 mil. To protect the circularly polarized metamaterial layer 103 from environmental exposure and physical damage, the circularly polarized metamaterial layer 103 is preferably positioned on the inner side of the dielectric carrier 101—that is, the side facing to the antenna.

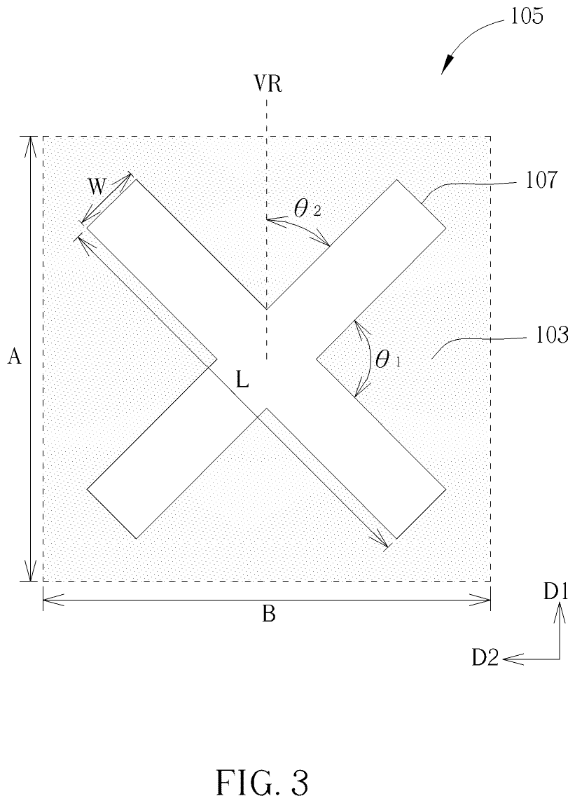

Please refer to FIG. 3, which illustrates a top-view diagram of a square unit cell 105 within the circularly polarized metamaterial layer 103 in accordance with an embodiment of the present invention. As shown in FIG. 3, in the embodiment, each square unit cell 105 defined in the circularly polarized metamaterial layer 103 is provided with an X-shaped opening 107. The X-shaped opening 107 is preferably symmetric and formed by two orthogonal intersecting lines, defining four arms that extend uniformly from a central intersection point, with the two intersecting lines having equal major axis lengths L and equal minor axis lengths W. Alternatively, the two intersecting lines of the X-shaped opening 107 may not be perfectly orthogonal. For example, the intersection angle (first angle) Θ₁ of the X-shaped opening 107 may fall within a range of 89° to 95°. Furthermore, the X-shaped opening 107 may be oriented, such that the angle (second angle) Θ₂ between one of its arm and a vertical reference line VR of the corresponding square unit cell 05 falls within a range of 40° to 50°. Although referred to as a “square” unit cell, in alternative embodiments, the unit cell 105 defined in the circularly polarized metamaterial layer 103 may have a different shape, such as a rectangle, where the length A in a first direction D1 is not equal to the length B in a second direction D2. The dimension of length A or B may fall within the range of 4.5 mm to 5.09 mm.

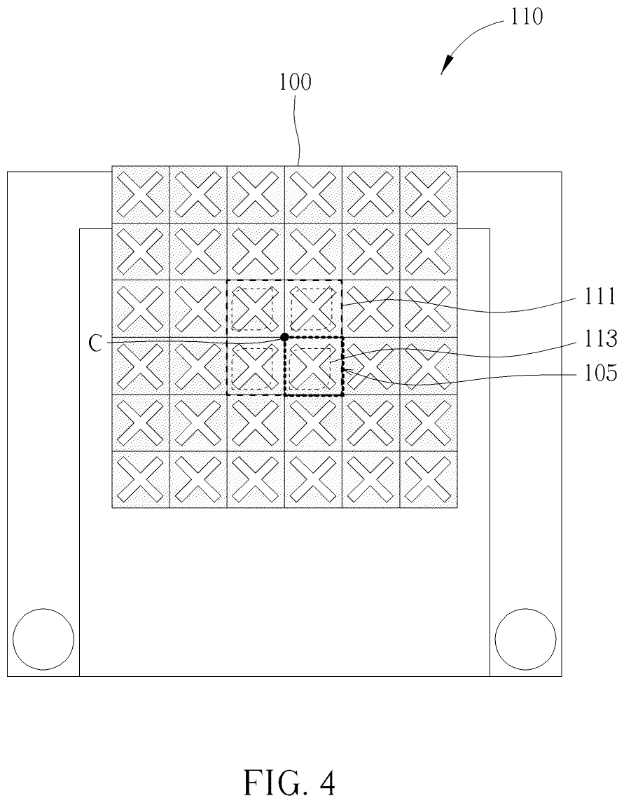

Please refer to FIG. 4, which illustrates a top-view diagram of an antenna assembly 110 in accordance with an embodiment of the present invention. In the present invention, the previously described radome 100, which incorporates the circularly polarized metamaterial layer, is specifically designed to serve as a protective cover or enclosure for an antenna. As shown in FIG. 4, the radome 100 and an antenna array 111 collectively form the antenna assembly 110. In the embodiment, the antenna array 111 may be implemented on an antenna substrate 112, which forms part of a complete antenna system, such as a directional antenna or a small scan angle antenna. In such applications, the radiation pattern gain of an individual antenna elements or antenna array can be improved by the radome 100 due to the presence of the circularly polarized metamaterial layer 103. The antenna array 111 consists of multiple individual antenna elements 113 arranged in a defined, specific geometric pattern—such as a 2×2 configuration—that operate together as a single, unified radiating or receiving antenna system. By adjusting the amplitude, phase, and spacing of each element, the array can achieve enhanced gain, beam steering capability, and improved directivity. In the present invention, the antenna elements 113 may include, but are not limited to, microstrip patch antennas, dipole antennas, slot antennas, horn antennas, or metamaterial-based radiating structures. The number of elements and their spatial arrangement—whether linear, planar, circular, or otherwise—determine the overall radiation characteristics and performance of the array. Specifically, in the embodiment shown in FIG. 4, the center point C of the antenna array 111 is aligned with the center of the radome 100. Each square unit cell 105, along with its corresponding X-shaped opening, is spatially matched to one of the respective antenna elements 113. This configuration is designed to achieve optimal gain performance by ensuring proper alignment between the metamaterial structure and the underlying antenna elements.

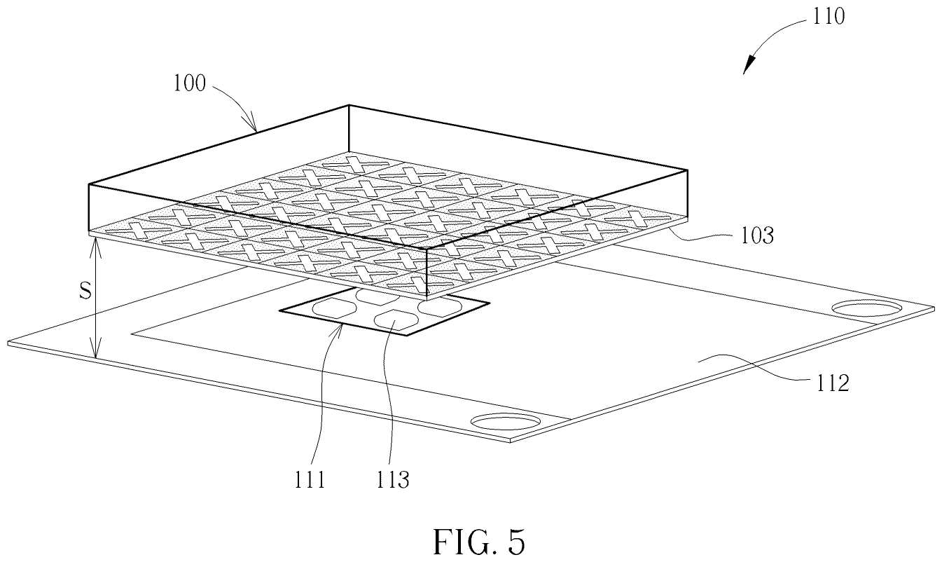

Please refer to FIG. 5, which presents an isometric view of the antenna assembly 110 in accordance with an embodiment of the present invention. As illustrated, the antenna assembly 110 includes the radome 100 and the antenna array 111, which is disposed beneath the radome 100 and fully overlaps its area. To achieve optimal gain performance, the antenna array 111 is precisely aligned with the radome 100 and spaced apart at a defined separation distance S. Each antenna element 113 within the array corresponds to one or more square unit cells 105 on the radome 100. The separation distance S, measured in a direction orthogonal to the plane of the radome 100 and the radiating/receiving surface of the antenna elements 113, is preferably in the range of 5.0 mm to 7.5 mm. Ideally, this distance S corresponds to half of the guided wavelength in the intervening air medium. Such a configuration helps to minimize the impact of standing wave null effects, thereby avoiding severe distortion in the antenna radiation pattern.

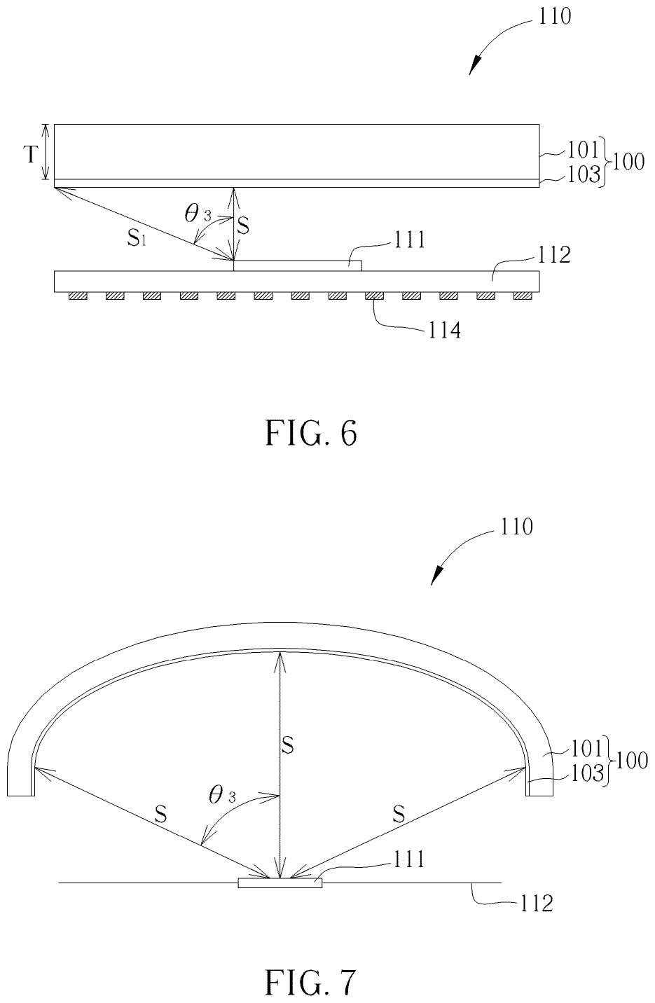

Please refer to FIG. 6, which illustrate a cross-sectional diagram of the antenna assembly 110 having a flat radome in accordance with an embodiment of the present invention. As shown in the figure, in the antenna assembly 110, the radome 100 is positioned above the antenna substrate 112, with its circularly polarized metamaterial layer 103 attached on the dielectric carrier 101 and oriented toward the antenna array 111 on the antenna substrate 112. Preferably, the antenna array 111 features a maximum radiation beamwidth of ±60° (Θ₃), corresponding to the beamwidths typical of the antennas used in current 5G communications and low Earth orbit (LEO) satellite communications. The area of the circularly polarized metamaterial layer 103 must therefore encompass the region where the antenna radiates upward within its maximum beamwidth. Consequently, the required number of X-shaped openings in the circularly polarized metamaterial layer 103 depends on both the size of the antenna array 111 and the distance S between the metamaterial layer 103 and the antenna array 111. Regarding the dimensional design, the thickness T of the dielectric carrier 101—measured in a direction perpendicular to the incident plane—is preferably an integer multiple of half the guided wavelength within the dielectric material of the radome 100 in order to mitigate standing wave null effects. The applicable frequency range for this design is from 20 GHz to 30 GHZ. It is important to note that the circularly polarized metamaterial layer 103 within the radome 100 is electrically floating with respect to both the ground terminals and the feed terminals 114 of the antenna array 111. In other words, the metamaterial layer 103 is neither physically nor electrically connected to the ground or the antenna array 111.

Regarding the material, in the present invention, the circularly polarized metamaterial layer 103 may be composed of dielectric and/or metallic materials. For example, dielectric materials such as ceramic, RO4835 or FR4—commonly used in printed circuit board (PCB) fabrication—can be employed. These materials typically have a thickness ranging from approximately 5 mil to 20 mil and a relative permittivity between 2.0 and 4.4. In general, a higher relative permittivity allows for a thinner circularly polarized metamaterial layer 103. Alternatively, the circularly polarized metamaterial layer 103 may be made of the same dielectric material as the dielectric carrier 101, such as polycarbonate (PC), which has a relative permittivity of about 2.8 to 3.0. In the case of metallic materials, suitable metals for the circularly polarized metamaterial layer 103 include gold (Au), silver (Ag), copper (Cu), aluminum (Al), and nickel (Ni), with a typical thickness ranging from 0.5 mil to 2 mil. The circularly polarized metamaterial layer 103 may be formed on the dielectric carrier 101 using various fabrication techniques, such as spraying, screen printing, photolithography, or electroplating.

Please refer to FIG. 7, which illustrate a cross-sectional diagram of the antenna assembly 110 having a curved radome in accordance with an alternative embodiment of the present invention. In this embodiment, the dielectric carrier 100 exhibits a curved profile as shown in the figure. As described in the previous embodiment, to prevent the formation of standing wave nodes caused by antenna radiation,—which can lead to significant distortion in the radiation pattern—the distance between the antenna and the radome is controlled to be an integer multiple of half the wavelength in air medium. Taking the flat radome as an example (as illustrated in FIG. 6), the spacing (i.e. distance S) at the center of the antenna assembly is designed to be approximately half a guided wavelength. However, at wider angles near the edges of the antenna assembly, the distance Si between the antenna array 111 and the radome 100 increases beyond half a wavelength. This variation can result in destructive interference, leading to reduced gain at oblique angles and even the appearance of side lobes. By incorporating the circularly polarized metamaterial with specific X-shaped openings, the forward gain can be improved while side-lobe levels are effectively suppressed. Moreover, in the case of a curved radome surface as illustrated in FIG. 7, the distance S between the antenna array 111 and the radome 100 can be more uniformly maintained as an integer multiple of half the guided wavelength. At wide angles on the edges of the antenna assembly 110, this distance S remains approximately equal to an integer multiple of half the wavelength, thereby minimizing destructive interference. When the circularly polarized metamaterial 103 with X-shaped openings is incorporated in this configuration, it enables enhanced gain performance across a broader angular range.

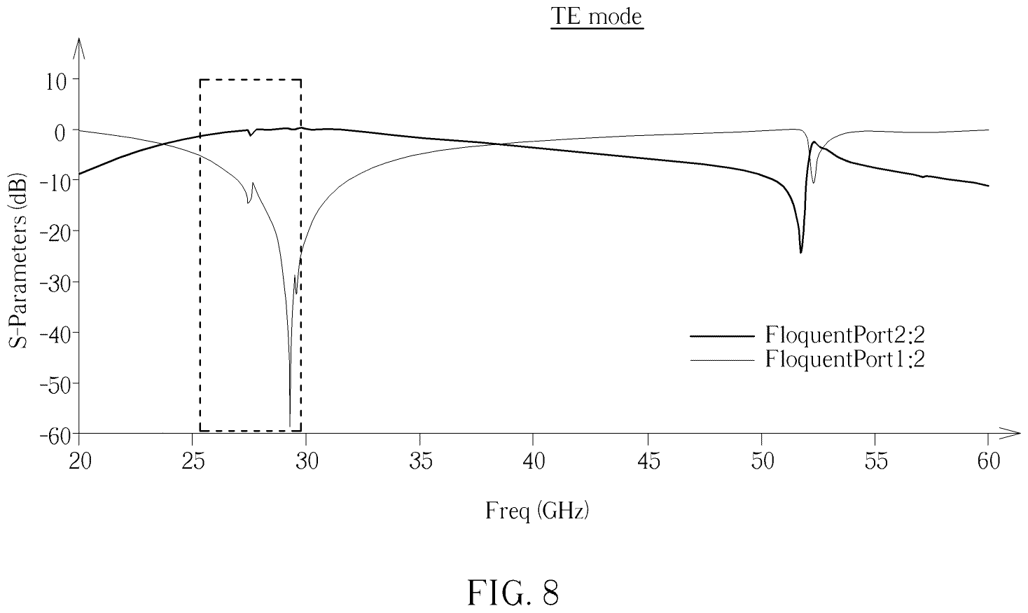

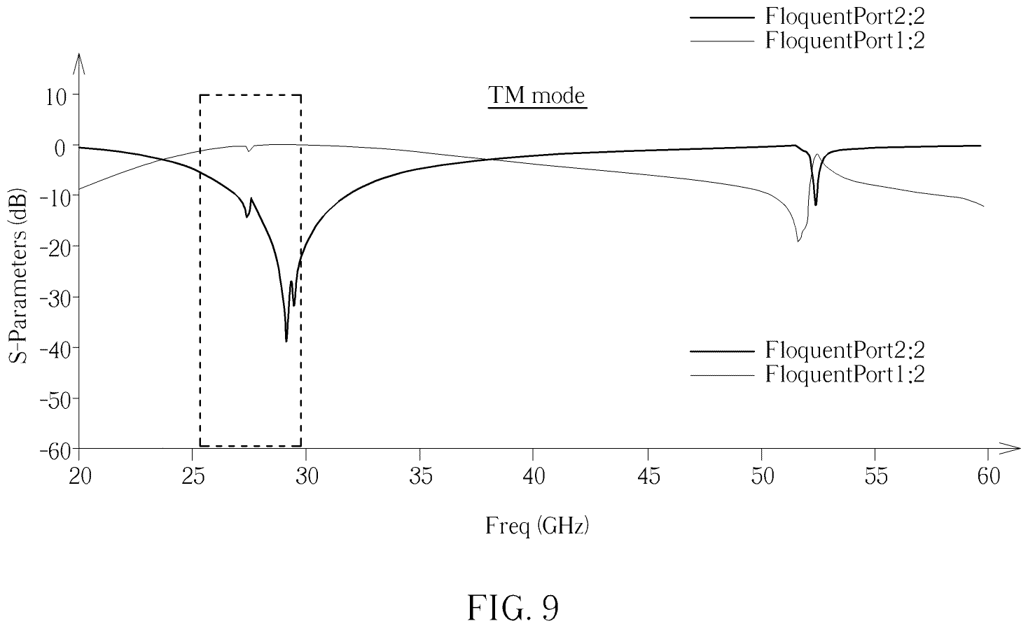

Please refer collectively to FIG. 8 and FIG. 9, which present plots of scattering parameters (S-parameters) versus frequency in the TE and TM modes, respectively, based on Floquet Port analysis of a dual-polarized antenna array incorporating the radome 100 or/and the square unit cells according to the present invention. The S-parameters in the TE modes and TM modes in this embodiment may also be referred to as horizontal and vertical S-parameter, respectively. This analysis was conducted using full-wave electromagnetic simulation via HFSS, a software developed by Ansys. In HFSS, Floquet ports are employed to analyze the propagation behavior of electromagnetic waves through periodic structures—such as the circularly polarized metamaterial 103 of the present invention. These plots illustrate how incident waves interact with the periodic structure, often with varying incident angles or polarizations. In modern 5G and low Earth orbit (LEO) satellite communication systems, dual-polarized and circularly polarized antenna arrays are commonly used as the primary RF transmission media. Unlike linearly polarized metamaterials—which are widely utilized in radar antenna systems to enhance detection range due to their ability to control polarization and suppress signal interference—circularly polarized metamaterials are better suited for communication systems. In radar applications, linearly polarized metamaterials are used to enhance microwave radiation via polarization selectivity. Conversely, communication systems demand antennas with broad coverage and the capability to receive signals from multiple directions. To enhance antenna gain under such conditions, circularly polarized metamaterials are preferred and are specifically engineered with a negative refractive index to fulfill this requirement. It is also worth noting that conventional linearly polarized metamaterials typically exhibit differing scattering behaviour in the TE and TM modes, resulting in distinct frequency bands where negative refractive index occurs. In contrast, as shown in FIG. 8 and FIG. 9, the radome 100 or/and the square unit cells incorporating the circularly polarized metamaterial layer 103 of the present invention demonstrates consistent negative refractive index characteristics across both TE and TM modes—approximately in the 25 GHz to 30 GHZ range. This is evidenced by the abrupt drop of the S-parameter curves of FloquetPort1:2 observed in the identified frequency range. Such uniform electromagnetic behavior across polarizations helps preserve the performance characteristics of dual-polarized and circularly polarized antennas, while also minimizing signal distortion during modulation and demodulation in both transmission and reception stages.

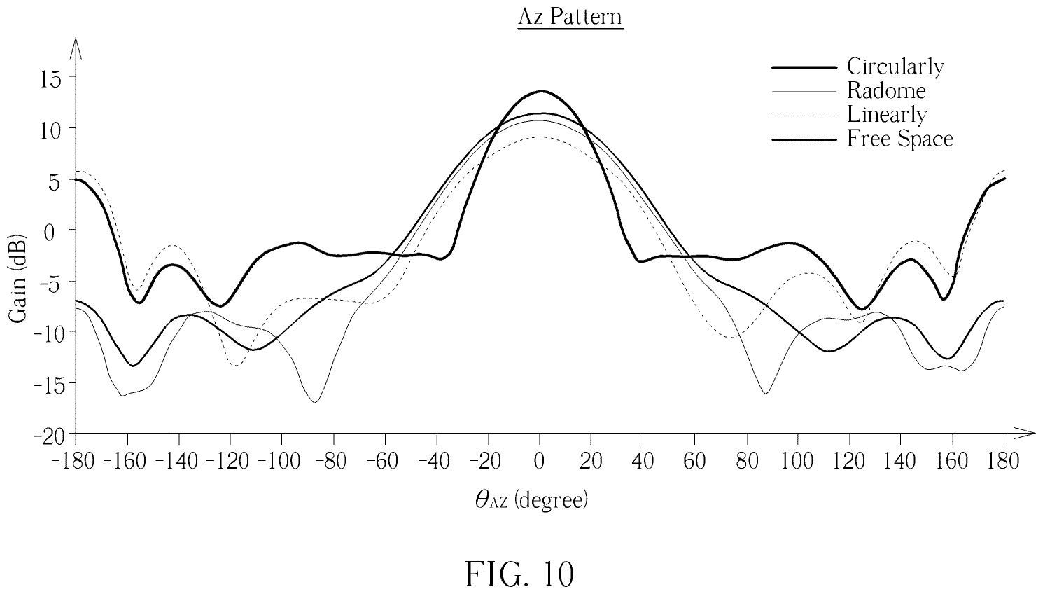

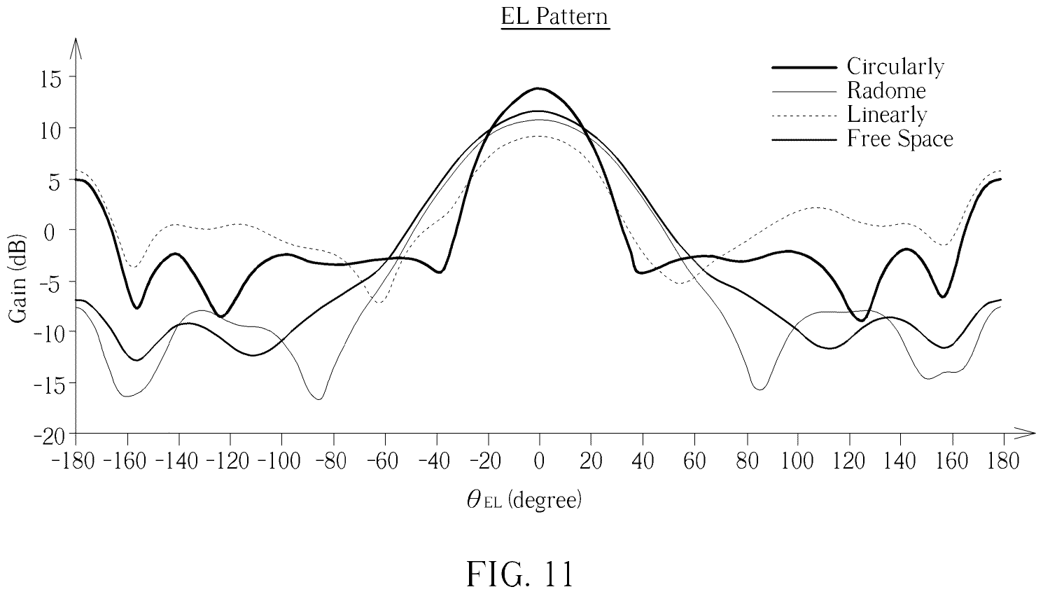

Please refer collectively to FIG. 10 and FIG. 11, which present plots of antenna gains versus Azimuth (Az) and Elevation (EL) angular coordinates, respectively. This analysis was conducted using full-wave electromagnetic simulation via HFSS, a software developed by Ansys, under four distinct conditions:
(A) Free Space: The antenna array is placed in an unobstructed, free-space environment.
(B) Radome: A standard radome made of polycarbonate (PC) is positioned at a distance of half a wavelength above the antenna array.
(C) Linearly: A linearly polarized metamaterial layer is attached to or embedded into the bottom side of the standard radome, also placed half a wavelength above the antenna.
(D) Circularly: The radome 100 with the circularly polarized metamaterial layer 103 of the present invention is positioned half a wavelength above the antenna array 111.

The Azimuth (Az) and Elevation (EL) angles are spatial coordinates used to describe the direction of electromagnetic radiation or reception. The azimuth angle (OAc) represents the horizontal orientation of the antenna beam relative to a reference direction (typically true north), while the elevation angle (OEL) represents the vertical orientation above or below the horizontal plane. These parameters are essential for characterizing an antenna's radiation pattern, referred herein as Az Pattern and EL pattern, respectively. As illustrated in the figures, the configuration with the circularly polarized metamaterial attached to or embedded into the radome (condition (D)) consistently demonstrates the highest gain performance in both Az and EL pattern. Notably, a gain improvement of up to 5 dB is observed when compared to the configuration using the linearly polarized metamaterial (condition (C)). Furthermore, for both/any Az and EL polarization directions, the radiation gain within a central angular range from −40° to +40° is significantly higher than the gain in the outer angular ranges from −180° to −41° and +41° to +180°, indicating strong directional performance and reduced side-lobe radiation. Besides, the figures demonstrate that the circularly polarized metamaterial significantly enhances antenna gain across the entire angular range in both the Azimuth (Az) and Elevation (EL) patterns, particularly when compared to the free-space condition and the configuration with a standard radome.

According to the above-described embodiment, it is evident that the present invention effectively enhances antenna gain for dual-polarized antennas, and the same improvement is also observed and proved in the application of circularly polarized and linearly polarized antennas. The circularly polarized metamaterial introduced in this invention offers outstanding gain enhancement, particularly in applications involving directional communication or antennas with narrow beam-scanning angles. It is also highly suitable for low Earth orbit (LEO) satellite communication systems employing mechanical rotation, as it allows for a reduction in the number of required antennas and consequently helps lower overall power consumption. Moreover, the circularly polarized metamaterial is compatible with dual-polarized antennas, providing gain enhancement without degrading cross-polarization isolation. Additionally, at the 28 GHz frequency band, the focal length of a traditional lens becomes excessively large, making it impractical to implement a conventional optical convex lens. To address this limitation, the present invention adopts a metamaterial-based design utilizing a negative refractive index to replace the traditional focusing mechanism. This approach enables a more compact and efficient focusing unit, significantly reducing the overall size and volume.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A radome with circularly polarized metamaterial, comprising:
a dielectric carrier; and
a circularly polarized metamaterial layer attached to or embedded into the dielectric carrier and electrically floating with respect to ground, the circularly polarized metamaterial layer comprises a plurality of X-shaped openings arranged in an array and exposing the dielectric carrier, and a first radiation pattern transmits through the circularly polarized metamaterial layer, resulting in a second radiation pattern with enhanced focusing characteristics compared to the first radiation pattern.

2. The radome with circularly polarized metamaterial of claim 1, wherein an intersection angle of the X-shaped opening falls within a range of 89° to 95°.

3. The radome with circularly polarized metamaterial of claim 1, wherein the X-shaped opening is symmetric and formed by two orthogonal intersecting lines, defining four arms that extend uniformly from a central intersection point, and the two intersecting lines have equal major axis lengths and equal minor axis lengths.

4. The radome with circularly polarized metamaterial of claim 1, wherein the circularly polarized metamaterial layer exhibits a negative refractive index.

5. The radome with circularly polarized metamaterial of claim 4, wherein an absolute value of the negative refractive index of the circularly polarized metamaterial layer is greater than a positive refractive index of the dielectric board.

6. The radome with circularly polarized metamaterial of claim 1, wherein a horizontal scattering parameter and a vertical scattering parameter of the circularly polarized metamaterial layer falls within the same frequency range.

7. The radome with circularly polarized metamaterial of claim 1, wherein the circularly polarized metamaterial layer comprises an array of square unit cells, with each of the square unit cells corresponding to one of the respective X-shaped openings.

8. The radome with circularly polarized metamaterial of claim 7, wherein the X-shaped opening is oriented such that an angle between one arm of the X-shaped opening and a vertical reference line of the corresponding square unit cell falls within a range of 40° to 50°.

9. The radome with circularly polarized metamaterial of claim 1, wherein the circularly polarized metamaterial layer and the dielectric carrier both have a quadrilateral shape, and the circularly polarized metamaterial layer is aligned such that edges of the circularly polarized metamaterial layer are parallel to edges of the dielectric carrier.

10. The radome with circularly polarized metamaterial of claim 1, wherein for both a first polarization direction and a second polarization direction, a radiation gain of the first polarization direction or/and the second radiation pattern within a central angular range from −40° to 40° is greater than the radiation gain within an outer angular ranges from −180° to −41° and from 41° to 180°.

11. The radome with circularly polarized metamaterial of claim 1, wherein the dielectric carrier exhibits a curved profile in a cross-sectional view.

12. The radome with circularly polarized metamaterial of claim 1, wherein the radome is an electromagnetic band-gap circuit board.

13. The radome with circularly polarized metamaterial of claim 1, wherein a relative permittivity of the dielectric carrier ranges from 2.0 to 4.4.

14. The radome with circularly polarized metamaterial of claim 1, wherein a thickness of the circularly polarized metamaterial layer ranges from 0.5 mil to 2 mil.

15. An antenna assembly, comprising:
an antenna array; and
a radome with circularly polarized metamaterial, wherein the antenna array is disposed beneath the radome and completely overlap the radome, and the radome comprises:
a dielectric carrier; and
a circularly polarized metamaterial layer attached to or embedded into the dielectric carrier and electrically floating with respect to ground and a feeding terminal of the antenna array, the circularly polarized metamaterial layer comprises a plurality of X-shaped openings arranged in an array and exposing the dielectric carrier, and a first radiation pattern transmits through the circularly polarized metamaterial layer, resulting in a second radiation pattern with enhanced focusing characteristics compared to the first radiation pattern.

16. The antenna assembly of claim 15, wherein a center of the antenna array is aligned with a center of the radome.

17. The antenna assembly of claim 15, wherein the antenna array comprises an array of antenna elements, and the circularly polarized metamaterial layer comprises an array of square unit cells, with each of the square unit cells corresponding to one of the respective antenna elements.

18. The antenna assembly of claim 15, wherein a distance between the antenna array and the radome is equal to an integer multiple of half a guided wavelength within an intervening air medium between the radome and the antenna array.

19. The antenna assembly of claim 18, wherein the distance between the antenna array and the radome ranges from 5.0 mm to 7.5 mm.

20. The antenna assembly of claim 15, wherein a thickness of the radome is equal to an integer multiple of half a guided wavelength within the dielectric carrier of the radome.

21. The antenna assembly of claim 15, wherein the circularly polarized metamaterial layer and the antenna array both have a quadrilateral shape, and the circularly polarized metamaterial layer is aligned such that edges of the circularly polarized metamaterial layer are parallel to edges of the antenna array.

22. The antenna assembly of claim 15, wherein the antenna array has a maximum radiation beamwidth of ±60°.
